(19) United States
(12) Patent Application Publication
(10) Pub. No.: US 2025/0153100 A1
(43) Pub. Date: May 15, 2025

(54) LOW PRESSURE LOW TEMPERATURE DIRECT AIR CAPTURE

(71) Applicant: EXXONMOBIL TECHNOLOGY AND ENGINEERING COMPANY, Spring, TX (US)

(72) Inventors: Arben Jusufi, Belle Mead, NJ (US); Mohsen S. Yeganeh, Newtown, PA (US); Mark A. King, Maplewood, NJ (US); Andrew R. Konicek, Whitehouse Station, NJ (US); Kevin M. Taylor, Denver, CO (US)

(21) Appl. No.: 18/941,529

(22) Filed: Nov. 8, 2024

Related U.S. Application Data
(60) Provisional application No. 63/597,590, filed on Nov. 9, 2023.

(51) Int. Cl. B01D 53/62; B01D 53/04

(52) U.S. Cl. CPC B01D 53/62; B01D 53/0407; B01D 2257/504; B01D 2258/02

(57) ABSTRACT

Systems and methods are provided for low temperature separation of sweep gas from desorbed components. This can allow for performance of sorption/desorption cycles at reduced temperatures and/or pressures. Methanol is an example of a sweep gas that can be used for desorption at reduced temperatures. CO₂ is an example of a component that can be sorbed and desorbed using a sorption/desorption cycle with reduced temperatures and/or pressures.

### CROSS REFERENCE TO RELATED APPLICATION

This Non-Provisional Patent application claims priority to U.S. Provisional Patent Application No. 63/597,590, filed Nov. 9, 2023, and titled “Low Pressure Low Temperature Direct Air Capture”, the entire contents of which is incorporated herein by reference.

### FIELD

Systems, methods, and corresponding sorbent materials are provided for performing direct air capture at low temperatures and low pressures.

### BACKGROUND

Carbon capture and regeneration are typically operated through significant temperature swings. During absorption the temperature is low, and the exact value depends on the application. For example, carbon capture from point sources, such as flue gases formed by heaters or power generators, carry out absorption at 50-60° C. while for direct air capture (DAC) absorption takes place close to ambient temperatures. With conventional technologies, regeneration takes place at much higher temperatures. Some current solid sorbent-based carbon capture technologies range between 80° C. and 130° C. for regeneration. Other technologies can use much higher regeneration temperatures, such as up to 480° C. or possibly still higher for some sorbents based on metal-organic framework materials.

The large temperature swings typically used for various carbon capture and regeneration technologies can pose a variety of challenges. First, achieving the large temperature swings, or thermal cycling, typically requires large expenditures of energy. For example, steam is often used as both the sweep gas and as the heat transfer medium for heating a sorbent environment to the target temperature. Generation of this steam can sometimes account for up to 80% or more of the total energy cost for performing a sorption/desorption cycle during carbon capture and subsequent regeneration of the sorbent.

In addition to high energy costs, the high temperatures needed for effective desorption for many sorbent systems can also contribute to degradation of the underlying sorbent. For example, for amine-based sorbents, temperatures of 100° C. or higher can often contribute to degradation of the amine-based sorbent.

It would be desirable to have systems and corresponding methods that can allow for carbon capture and regeneration with reduced temperatures for sorption and desorption and/or reduced differentials between the temperatures for sorption and desorption.

An example of a journal article related to direct air capture is N. McQueen, et al., “A review of direct air capture (DAC): scaling up commercial technologies and innovating for the future,” Prog. Energy, vol. 3, p. 032001, 2021.

Another example of a journal article related to direct air capture is M. Fasihi, et al., “Techno-economic assessment of CO2 direct air capture plants,” Journal of Cleaner Production, vol. 224, pp. 957-980, 2019.

U.S. Pat. No. 11,439,927 describes a species extraction apparatus for liquid-based extractions.

U.S. Pat. No. 11,590,447 relates to a porous liquid or a porous liquid enzyme that includes a high surface area solid and a liquid film substantially covering the high surface area solid. The porous liquid or porous liquid enzyme may be contacted with a fluid that is immiscible with the liquid film such that a liquid-fluid interface is formed. The liquid film may facilitate mass transfer of a substance or substrate across the liquid-fluid interface, Methods of performing liquid-based extractions and enzymatic reactions utilizing the porous liquid or porous liquid enzyme are also provided.

U.S. Patent Application Publication 2020/0147543 also relates to a porous liquid or a porous liquid enzyme that includes a high surface area solid and a liquid film substantially covering the high surface area solid.

### SUMMARY

In an aspect, a method for recovering a sweep gas is provided. The method includes heating a sweep liquid to a first temperature to form a sweep gas at a first vapor pressure, the first temperature being equal to or less than a boiling point for the sweep liquid at 100 kPa-a, the first temperature being 85° C. or less. The method further includes exposing a sorbent bed in a sorbent environment to at least a portion of the sweep gas, at a sweep pressure in the sorbent environment of 90 kPa-a or less and a sweep temperature in the sorbent environment corresponding to the first temperature or higher, to form a desorption effluent containing the sweep gas and at least one desorbed component, the sweep pressure being at the first vapor pressure or lower. The method further includes reducing the temperature of at least a portion of the desorption effluent to a temperature below the first temperature to form a first intermediate effluent enriched in the at least one desorbed component and a first condensed sweep liquid, a pressure during the reducing the temperature being 90 kPa-a or less. The method further includes increasing the pressure of at least a portion of the first intermediate effluent to a pressure between 90 kPa-a and 200 kPa-a to form a second intermediate effluent and a second condensed sweep liquid. Additionally, the method includes compressing at least a portion of the second intermediate effluent to a pressure greater than 200 kPa-a to form a compressed condensed sweep liquid and a desorption product. Optionally, the heating of the sweep liquid can correspond to heating a) at least a portion of the first condensed sweep liquid, b) at least a portion of the second condensed sweep liquid, c) at least a portion of the compressed condensed sweep liquid, or d) a combination of two or more of a), b), and c).

In another aspect, a system for recovering a sweep gas is provided. The system includes a sweep gas heating stage for heating a sweep liquid at a pressure of less than 90 kPa-a to form a sweep gas, the sweep gas heating stage having a liquid inlet, a recycle inlet, and a sweep gas outlet. The system further includes a sorbent environment containing a sorbent bed, the sorbent environment having a sorbent sweep gas inlet in fluid communication with the sweep gas outlet, and a desorption effluent outlet. The system further includes a first condensation vessel having a first condensation vessel inlet in fluid communication with the desorption effluent outlet, a first condensation vessel gas outlet, and a first condensation vessel liquid outlet. The system further includes a second condensation vessel having a second condensation vessel inlet in fluid communication with the first condensation vessel gas outlet, a second condensation vessel gas outlet, and a second condensation vessel liquid outlet. Additionally, the system includes a compression stage having a compressor inlet in fluid communication with the second condensation vessel gas outlet, a compression gas outlet, and a compression liquid outlet. Optionally, the recycle inlet can be in fluid communication with at least one of the first condensation vessel liquid outlet, the second condensation vessel liquid outlet, and the compression liquid outlet.

In still another aspect, a method for capturing CO₂ is provided. The method includes exposing a CO₂-containing gas to a sorbent bed in a sorbent environment under sorption conditions including a sorbent environment temperature of 30° C. or less to form a sorbent bed having sorbed CO₂ and a CO₂-depleted effluent. The method further includes exposing the sorbent bed to a sweep gas under desorption conditions including a sorbent environment temperature of 70° C. or less to form a desorption effluent containing at least a portion of the sorbed CO₂ and at least a portion of the sweep gas. The sweep gas can correspond to 80 mol % or more of one or more non-aqueous components having a boiling point between 20° C. and 85° C. at 100 kPa-a, and a molar ratio of the one or more non-aqueous components to CO₂ in the desorption effluent can be 1.0 or more. The method further includes separating the desorption effluent to form a gas phase effluent containing 90 mol % or more of CO₂ and one or more liquid phase fractions containing 80 mol % or more of the one or more non-aqueous components. Additionally, the method includes heating at least a portion of the one or more liquid phase fractions to form at least a portion of the sweep gas.

In yet another aspect, a method for capturing CO₂ is provided. The method includes exposing a CO₂-containing gas to a sorbent bed in a sorbent environment under sorption conditions including a sorbent environment temperature of 30° C. or less to form a sorbent bed having sorbed CO₂ and a CO₂-depleted effluent. The method further includes exposing the sorbent bed to a sweep gas under desorption conditions including a sorbent environment temperature of 100° C. or less to form a desorption effluent containing at least a portion of the sorbed CO₂ and at least a portion of the sweep gas. The sweep gas can include one or more sweep gas components. The sweep gas can contain 5.0 mol % or more of water. A molar ratio of the one or more sweep gas components to CO₂ in the desorption effluent can be 1.0 or more. The method further includes separating the desorption effluent to form a gas phase effluent containing 90 mol % or more of CO₂ and one or more liquid phase fractions containing 80 mol % or more of the one or more sweep gas components. Additionally, the method includes heating at least a portion of the one or more liquid phase fractions to form at least a portion of the sweep gas.

In still another aspect, a method for capturing CO₂ is provided. The method includes exposing a CO₂-containing gas to a sorbent bed in a sorbent environment under sorption conditions including a sorbent environment temperature of 30° C. or less to form a sorbent bed having sorbed CO₂ and a CO₂-depleted effluent. The method further includes exposing the sorbent bed to a sweep gas under desorption conditions including a sorbent environment temperature of 65° C. or less to form a desorption effluent containing at least a portion of the sorbed CO₂ and at least a portion of the sweep gas. The sweep gas can contain 80 mol % or more of methanol. A molar ratio of methanol to CO₂ in the desorption effluent can be 1.0 or more. The method further includes separating the desorption effluent to form a gas phase effluent containing 90 mol % or more of CO₂ and one or more liquid phase fractions containing 80 mol % or more of methanol. Additionally, the method includes heating at least a portion of the one or more liquid phase fractions to form at least a portion of the sweep gas.

### BRIEF DESCRIPTION OF THE DRAWINGS

FIG. 1 shows an example of a configuration for recovering a sweep gas.

FIG. 2 shows an example of a structure for supporting a reactive liquid.

FIG. 3 shows another example of a structure for supporting a reactive liquid.

FIG. 4 shows an example of an external housing for a structure for supporting a reactive liquid.

FIG. 5 shows CO₂ sorption on a SWIRL-TEPA sorbent during an adsorption and regeneration cycle.

FIG. 6 shows how maximum CO₂ sorption capacity varies for a SWIRL-TEPA sorbent.

FIG. 7 shows CO₂ sorption on a SWIRL-MMBA sorbent during an adsorption and regeneration cycle.

FIG. 8 shows CO₂ sorption on a SWIRL-MMBA sorbent during an adsorption and regeneration cycle.

FIG. 9 shows how the ratio of sweep gas to CO₂ varies with regeneration temperature for SWIRL-BMMA.

### DETAILED DESCRIPTION

All numerical values within the detailed description and the claims herein are modified by “about” or “approximately” the indicated value, and take into account experimental error and variations that would be expected by a person having ordinary skill in the art.

### Overview

In various aspects, systems and methods are provided for low temperature, low pressure sorption and desorption processes. Direct air capture is an example of a sorption/desorption process that can be performed at low temperature, low pressure conditions. The partial pressure of CO₂ in air is roughly 400 vppm (˜0.04 kPa). More generally, low gas pressure is defined herein as being below 10 kPa for the partial gas pressure of the component being sorbed. Low temperature describes the temperature at which CO₂ capture (and/or sorption of other components) and sorbent regeneration takes place. Typical direct air capture technologies using solid sorbent filter materials need to heat their materials to high temperatures (80-130° C.) for CO₂ regeneration. By comparison, any technology using temperatures of 70° C. or less can be considered ‘low temperature’.

By using amines (and/or other sorbents) that can perform a sorption/desorption cycle at low temperature, a variety of options can be enabled for reducing or minimizing the costs associated with capturing a gas phase component and then desorbing the component to regenerate the sorbent for the next sorption/desorption cycle. In some aspects, a benefit of low temperature, low pressure operation can be an increase in the types of sweep gases that can be used. For example, methanol has a boiling point of roughly 65° C. at 100 kPa-a. As a result, in comparison with water, methanol has relatively high equilibrium vapor pressures at temperatures between 20° C. and 60° C. This means that a relatively pure gas phase of methanol at a relatively high vapor pressure can be formed simply by heating methanol in a vessel to a temperature between 20° C. and 60° C. This gas phase can then be used as a sweep gas for a sorbent system that allows for desorption of sorbed components at temperatures between 20° C. and 60° C. Optionally, the desorption can be performed in a reduced pressure environment, so that the methanol plus any component(s) desorbed from the sorbent correspond to 90 vol % or more of the gas phase in the sorbent environment during desorption, such as having substantially the entire gas phase correspond to methanol and the desorbed component(s).

In some aspects, another advantage of operating at low temperature is that energy requirements for operating a sorption/desorption cycle can be reduced. The lower energy requirement can be based simply on the savings due to lower temperature requirements for both sorption and desorption, and/or the lower energy requirement can be based on a reduced temperature differential between sorption and desorption. Optionally, further energy savings can be achieved if alternative heat sources can be used. For example, if desorption can be performed at temperatures between 30° C. and 40° C., daytime air temperatures might be sufficient for heat exchange. In such a process, if sorption is performed at between 0° C. to 10° C., ocean water from a sufficient depth can provide a reservoir of liquid for heat exchange to a target temperature. In still other instances, geothermal energy might be sufficient to achieve target temperatures of 70° C. or less.

In some aspects, still another advantage of operating at low temperature can be improvements in the operating lifetime of the sorbent material. For example, amine-based sorbents are known to have reduced lifetimes when operated at temperatures of 100° C. or higher. By performing the full sorption/desorption cycle at temperatures of 70° C. or less, such degradation of an amine-based sorbent can be reduced, minimized, or avoided.

Additionally or alternately, in some aspects, another benefit of low temperature, low pressure operation is that improved systems and methods for sweep gas recovery can be used. For example, a multi-stage system can be used to separate a sweep gas (such as methanol) from a desorbed component (such as CO₂) in order to produce a high purity stream of the desorbed component while also achieving high recovery of the sweep gas.

Further additionally or alternately, in some aspects, a sorption device for performing low temperature, low pressure sorption and desorption can utilize the principles of solids with infused reactive liquids (SWIRL). SWIRL consists of porous substrates, made from filaments, fiber, plates, or some other high surface area-to-volume (A/V) geometry, that immobilize a liquid film within the surface roughness through strong capillary forces. The size of the porous voids lies in the range of 0.1 μm-2000 μm. The surface roughness features are such that a wetting liquid is infused and creates a stable liquid film on the substrates with a wetting film thickness in the range of 0.1 μm-500 μm. The overall structures exhibit a high A/V ratio of 2,000 m⁻¹ or higher. This A/V ratio is approximately 10 times higher than that of a conventional amine scrubber. The infused reactive liquid is in direct contact with the surrounding gas that flows through the opening of the structure with little to no mass transfer resistance. This, in turn, allows the infused reactive liquid to readily react with chemical species in the surrounding gas. The high A/V allows high contact of the flowing gas stream with the reactive liquid such that a desired gas species (such as CO₂) is absorbed and separated from the entire gas flow until the liquid is partially loaded or fully loaded (i.e., saturated) with the sorbed component.

As an example of an application, CO₂ capture from air can be performed using an amine liquid that is supported on a solid support with a high A/V ratio. For example, air with ˜400 ppm CO₂ and an amine liquid that absorbs selectively CO₂ from ambient air can be used to perform CO₂ capture without any prior CO₂ enrichment or increased air pressure.

### Definitions

In this discussion, reference may be made to various types of fluids, such as non-aqueous solvents, liquids, and/or other fluids; carbon-containing components that are fluids/liquids/solvents, and organic components that are fluids/liquids/solvents. It is noted that a fluid can correspond to a liquid, a gas, or a substance that is a fluid phase that is neither liquid or gas due to being beyond the critical point for the fluid.

In this discussion, a non-aqueous fluid, such as a non-aqueous solvent or non-aqueous liquid, refers to any type of fluid that contains less than 5.0 mol % of water relative to the volume of the fluid. Optionally but preferably, a non-aqueous fluid can have a water content of less than 1000 vppm (volume parts per million), or less than 100 vppm, such as down to being substantially free of water (10 vppm or possibly still lower).

In this discussion, a carbon-containing component and/or carbon-containing liquid is defined as one or more compounds that contain carbon. The carbon-containing component and/or liquid (such as a carbon-containing solvent) can include conventional organic compounds, as well as other carbon-containing compounds that may not necessarily be considered as organic compounds, such as some types of refrigerants. A carbon-containing component and/or liquid is defined to contain 5.0 mol % or less of compounds that do not contain carbon (e.g., water). Optionally, a carbon-containing component and/or liquid can have a content of compounds that do not contain carbon of 1.0 mol % or less, such as down to being substantially free of compounds that do not contain carbon (1000 vppm or less). Optionally, the carbon-containing component and/or liquid can contain 90 mol % or more of a single carbon-containing compound, or 95 mol % or more of a single carbon-containing compound, such as up to be substantially composed of a single carbon-containing compound.

In this discussion, an organic component and/or organic liquid is defined as one or more compounds that are organic compounds, and therefore have at least one carbon-hydrogen bond in the chemical structure of the compound. An organic component and/or liquid (such as an organic solvent) is defined to contain 5.0 mol % or less of non-organic compounds. Optionally, an organic component and/or liquid can have a content of non-organic compounds of 1.0 mol % or less, such as down to be substantially free of non-organic compounds (1000 vppm or less). Optionally, the organic component and/or liquid can contain 90 mol % or more of a single carbon-containing compound, or 95 mol % or more of a single carbon-containing compound, such as up to be substantially composed of a single carbon-containing compound.

### Sweep Gas Recovery System

In various aspects, one feature of performing low temperature, low pressure sorption/desorption cycle is that an improved sweep gas recovery system (and corresponding sweep gas recovery method) can be used. The improved sweep gas recovery system and/or method can allow for generation of a high concentration stream of the gas component(s) desorbed from the sorbent while also providing high recovery of the sweep gas for recycle. The sweep gas recovery system can correspond to a multi-stage recovery system that utilizes variations in both temperature and pressure across the various stages.

A preliminary “stage” of the sweep gas recovery system corresponds to a sorbent environment where sweep gas is used to assist with desorption of a sorbed component. Performing desorption under suitable conditions and using a suitable sweep gas can facilitate using the sweep gas recovery system and method.

In various aspects, the sweep gas used for desorption can correspond to a gas containing one or more non-aqueous compounds that have a boiling point between 20° C. and 85° C. at atmospheric pressure (˜100 kPa-a). Some examples of non-aqueous solvents include organic oxygenates, alcohols (such as methanol, ethanol, and/or isopropyl alcohol), and/or refrigerants. Mixtures of non-aqueous components can also be used to form a sweep gas, but due to differences in vapor pressure curves, using a mixture of such components to form a sweep gas can potentially increase the complexity of sweep gas management. More generally, any convenient type of aqueous or non-aqueous component can be used so long as the CO₂ purity in the final separation stage is sufficiently high, the loss of sweep gas in high pressure and/or supercritical CO₂ is economically acceptable, and the CO₂ concentration in the recycled stream is in the 100s of ppm levels or lower.

In order to prepare a sweep gas for use, a substantially pure liquid phase of the non-aqueous component (and/or carbon-containing component, and/or organic component) can be heated in a sweep gas heater or boiler. The boiler can be substantially free of N₂, air, and/or other gases that are not readily separated from CO₂ in the sweep gas separation system. The sweep gas heater or boiler is heated to a temperature below the boiling point for the non-aqueous component in order to form a vapor phase at roughly the equilibrium vapor pressure for the non-aqueous component. This serves as a reservoir for the sweep gas at the vapor pressure. In some aspects, the pressure of the vapor phase can correspond to a pressure that is less than ambient (i.e., a pressure below roughly 90 kPa-a). In such aspects, the vapor phase can optionally be used to facilitate desorption in a sorbent environment under vacuum conditions (i.e., desorption conditions where the pressure in the sorbent environment is less than roughly 90 kPa-a). For example, in some aspects, the pressure of the vapor phase can be between 10 kPa-a to 90 kPa-a, or 15 kPa-a to 90 kPa-a, or 20 kPa-a to 90 kPa-a, or 10 kPa-a to 70 kPa-a, or 15 kPa-a to 70 kPa-a, or 20 kPa-a to 70 kPa-a, or 50 kPa-a to 90 kPa-a. In other aspects, the pressure in the vapor phase can correspond to roughly ambient pressure or higher. In some aspects, the pressure in the vapor phase can be 10 kPa-a to 150 kPa-a, or 15 kPa-a to 150 kPa-a, or 20 kPa-a to 150 kPa-a, or 10 kPa-a to 110 kPa-a, or 15 kPa-a to 110 kPa-a, or 20 kPa-a to 110 kPa-a, or 50 kPa-a to 150 kPa-a, or 50 kPa-a to 110 kPa-a, or 90 kPa-a to 150 kPa-a, or 90 kPa-a to 110 kPa-a.

More generally, in some aspects a sweep liquid can be used to form a sweep gas where the sweep liquid contains 80 mol % or more of one or more non-aqueous components, or 85 mol % or more, or 90 mol % or more, or 95 mol % or more, such as up to having a sweep liquid that is substantially completely composed (99 mol % or more) of one or more non-aqueous components. Optionally, the sweep liquid can be substantially completely composed of a single non-aqueous component. Additionally or alternately, in some aspects a sweep liquid can be used to form a sweep gas where the sweep liquid contains 80 mol % or more of one or more carbon-containing components, or 85 mol % or more, or 90 mol % or more, or 95 mol % or more, such as up to having a sweep liquid that is substantially completely composed (99 mol % or more) of one or more carbon-containing components. Optionally, the sweep liquid can be substantially completely composed of a single carbon-containing component. Further additionally or alternately, in some aspects a sweep liquid can be used to form a sweep gas where the sweep liquid contains 80 mol % or more of one or more organic components, or 85 mol % or more, or 90 mol % or more, such as up to having a sweep liquid that is substantially completely composed (99 mol % or more) of one or more organic components. Optionally, the sweep liquid can be substantially completely composed of a single organic component.

It is noted that the liquid phase in the sweep gas heater can correspond to a plurality of non-aqueous components and/or carbon-containing components and/or organic components, instead of just a single component. In aspects where the liquid phase in the sweep gas heater includes a plurality of non-aqueous components, the sweep gas heater is heated to a temperature below the boiling point of the lowest boiling non-aqueous component. In aspects where the liquid phase in the sweep gas heater includes a plurality of carbon-containing components, the sweep gas heater is heated to a temperature below the boiling point of the lowest boiling carbon-containing component. In aspects where the liquid phase in the sweep gas heater includes a plurality of organic components, the sweep gas heater is heated to a temperature below the boiling point of the lowest boiling organic component. In various aspects where the sweep gas corresponds to a plurality of non-aqueous components and/or carbon-containing components and/or organic components, the temperature in the sweep gas heater can be 15° C. to 70° C., or 35° C. to 70° C., or 15° C. to 50° C., or 15° C. to 35° C. The pressure in the sweep gas heater can correspond to the equilibrium vapor pressure for the non-aqueous component at the temperature in the sweep gas heater. In this discussion, it is noted that components that are present in the liquid phase in an amount of less than 1.0 vol % are defined as impurities, and therefore are not considered as separate non-aqueous components/carbon-containing components/organic components for the purpose of determining the number of components in the sweep gas heater and/or the temperature for operating the sweep gas heater. In this discussion, the operation of a sweep gas recovery system is described with reference to a sweep gas corresponding to a single non-aqueous component (such as methanol, which is also carbon-containing and organic), but it is understood that a mixture of non-aqueous/carbon-containing/organic components can be used unless otherwise specified. In some aspects, a sweep gas can consist essentially of a single non-aqueous and/or carbon-containing and/or organic component.

In some alternative aspects, an aqueous-based sweep liquid can be used. An aqueous-based sweep liquid is defined as a sweep liquid that contains 5.0 mol % or more of water. Optionally, an aqueous-based sweep liquid can be substantially composed of water (1.0 mol % or less of components different from water). In aspects where an aqueous-based sweep liquid is used instead of a non-aqueous sweep liquid, the temperature in the sweep gas heater can be between 15° C. to 120° C., or 15° C. to 105° C., or 15° C. to 100° C., or 15° C. to 90° C., or 15° C. to 70° C., or 15° C. to 50° C., or 30° C. to 120° C., or 30° C. to 105° C., or 30° C. to 100° C., or 30° C. to 90° C., or 30° C. to 70° C., or 50° C. to 120° C., or 50° C. to 105° C., or 50° C. to 100° C., or 50° C. to 90° C.

The vapor phase formed in the sweep gas heater or boiler can then be used as a sweep gas during a desorption step of a sorption/desorption cycle. During the desorption step, the temperature in the sorbent environment is maintained at a temperature similar to and/or greater than the temperature in the sweep gas heater. By maintaining a temperature in the sorbent environment that is at or above the temperature in the sweep gas heater while maintaining the pressure in the sorbent environment at a roughly similar level (or lower) as compared to the sweep gas heater, the potential for condensation of the sweep gas in the sorbent environment is reduced, minimized, or eliminated. Optionally, the temperature in the sorbent environment during desorption can be substantially similar to the temperature in the sweep gas heater. Two temperatures are defined as being substantially similar when the difference between the temperatures is 5° C. or less. The pressure in the sorbent environment during desorption can be a pressure that is at or below the vapor pressure of the non-aqueous component in the sweep gas heater. This again minimizes or avoids condensation of the sweep gas during desorption. Also, to the degree that the pressure in the sorbent environment is lower than the vapor pressure in the sweep gas heater, the vapor pressure in the sweep gas heater can provide at least a portion of the driving force for passing the sweep gas into the desorption environment. Optionally, no blower or other device is needed to provide the target flow rate of sweep gas into the desorption environment. In some aspects, a vacuum pump such as a liquid ring pump can be used to drive a flow of sweep gas from the sweep gas heater to the sorbent environment.

In some aspects, sweep gas can contain 80 mol % or more of one or more non-aqueous components, or 85 mol % or more, or 90 mol % or more, or 95 mol % or more, such as up to having a sweep gas that is substantially completely composed (99 mol % or more) of one or more non-aqueous components. Optionally, the sweep gas can be substantially completely composed of a single non-aqueous component. Additionally or alternately, in some aspects a sweep gas can contain 80 mol % or more of one or more carbon-containing components, or 85 mol % or more, or 90 mol % or more, or 95 mol % or more, such as up to having a sweep gas that is substantially completely composed (99 mol % or more) of one or more carbon-containing components. Optionally, the sweep gas can be substantially completely composed of a single carbon-containing component. Further additionally or alternately, in some aspects a sweep gas can contain 80 mol % or more of one or more organic components, or 85 mol % or more, or 90 mol % or more, such as up to having a sweep gas that is substantially completely composed (99 mol % or more) of one or more organic components. Optionally, the sweep gas can be substantially completely composed of a single organic component.

During desorption, the sweep gas facilitates desorption of one or more sorbed components from the sorbent. This results in desorption effluent containing the sweep gas component(s), such as non-aqueous components, and one or more desorbed components. In the desorption effluent, a molar ratio of the sweep gas component(s) to the one or more desorbed components is greater than 1.0, such as 1.5 or more, or 5.0 or more, and possibly up to 100 or even higher. The mixture of sweep gas and desorbed component(s) is then passed into a first separation stage. In the first separation stage, a portion of the sweep gas (e.g., non-aqueous component) is condensed so that the stage produces a high purity liquid of the non-aqueous component and first intermediate gas phase effluent with a molar ratio of the sweep gas component(s) to the one or more desorbed components of less than 2.0, or 1.5 or less, or 1.0 or less, or 0.5 or less, such as down to 0.05 or possibly still lower. To achieve this, the temperature in the first separation stage is lower than the temperature in the sweep gas heater, while the pressure in the first separation stage is substantially similar to the pressure in the sorbent environment. This results in the partial pressure of the sweep gas component(s) in the first separation stage being greater than the equilibrium vapor pressure at the temperature in the first separation stage. Thus, a liquid phase of the sweep gas component(s) forms, but little or none of the desorbed component(s) will be present in the liquid phase. In this discussion, two pressures are defined as substantially similar when the difference between the pressures is 3.0 kPa or less. In various aspects, the temperature in the first separation stage can be lower than the temperature in the sweep gas heater and/or lower than the temperature in the sorbent environment by 0° C. to 50° C., or 0° C. to 30° C., or 0° C. to 20° C., or 5° C. to 50° C., or 5° C. to 30° C., or 5° C. to 20° C., or 15° C. to 50° C., or 15° C. to 30° C. In some aspects, the temperature in the first separation stage can be 0° C. to 65° C., or 0° C. to 50° C., or 0° C. to 40° C., or 15° C. to 65° C., or 15° C. to 50° C., or 15° C. to 40° C., or 30° C. to 65° C., or 30° C. to 50° C.

The first intermediate effluent from the first separation stage is then passed into a second separation stage for further separation of the sweep gas component(s) from the one or more desorbed components. In the second separation stage, the temperature is maintained at substantially the same temperature as the first separation stage, but the pressure in the second separation stage is increased to roughly ambient pressure or higher. In various aspects, the pressure in the second separation stage can be 90 kPa-a to 200 kPa-a, or 90 kPa-a to 150 kPa-a, or 90 kPa-a to 110 kPa-a, or 120 kPa-a to 200 kPa-a. A blower, pump, or other suitable device can be used to increase the pressure of the first intermediate effluent so that it can be passed into the second separation stage. Because the second separation stage operates at higher pressure, the partial pressures of the sweep gas component(s) and the one or more desorbed components are increased proportionally. This results once again in the vapor pressure of the sweep gas component(s) being greater than the equilibrium vapor pressure at the temperature in the second separation stage, resulting in condensation. In some aspects, the temperature in the second separation stage can be 0° C. to 65° C., or 0° C. to 50° C., or 0° C. to 40° C., or 15° C. to 65° C., or 15° C. to 50° C., or 15° C. to 40° C., or 30° C. to 65° C., or 30° C. to 50° C. A second intermediate gas phase effluent is also produced. A molar ratio of the sweep gas component(s) to the one or more desorbed components in the second intermediate effluent can be 0.1 or less, 0.05 or less, or 0.01 or less, such as down to 0.005 or possibly still lower.

The second intermediate effluent is then passed into a compression stage. In the compression stage, one or more compression steps are used to substantially separate the remaining organic component from the one or more desorbed components. The compression stage can produce a compressed effluent containing the one or more desorbed components at a pressure of 2.0 MPa-a to 5.0 MPa-a. It is noted that the pressure can be selected so that the CO₂ stays in the gas phase and does not undergo condensation. Thus, the pressure of the compressed effluent can vary depending on the temperature in the compression stage. In some aspects, the temperature in the compression stage can be substantially similar to the temperature in the second separation stage. In some aspects, the temperature in the compression stage can be 15° C. to 65° C., or 15° C. to 50° C., or 15° C. to 40° C., or 30° C. to 65° C., or 30° C. to 50° C. The compressed effluent can contain a reduced or minimized amount of the sweep gas component(s). The molar ratio of sweep gas component(s) to one or more desorbed components in the compressed effluent can be 0.005 or less, or 0.001 or less, such as down to having substantially no content of the sweep gas component(s) (molar ratio of 0.0005 or less). A liquid effluent of the sweep gas component(s) is also produced. It is noted that the resulting pressure of the compressed effluent may cause the one or more desorbed components to be at conditions that are at or near supercritical conditions which is a desired state for CO₂ transportation and storage. Some types of desorbed components (such as CO₂) may have increased solubility in a sweep gas component under conditions that are at or near supercritical conditions. Such combinations of sweep gas component(s) and desorbed components should be avoided, so that the molar ratio of sweep gas component(s) to desorbed component(s) is maintained at 0.005 or less in the compressed effluent.

The liquid effluents from each separation stage can then be recycled back to the sweep gas heater. It is noted that the separation stages may include more than one separator in order to reduce the content of the one or more desorbed components in the liquid recycle. For example, for the first separation stage, the liquid exiting from a primary separator in the separation stage can be passed into a secondary gas-liquid separator to further remove the one or more desorbed components from the liquid effluent. Similar secondary gas-liquid separators can be used for any separation stage to reduce or minimize recycle of the one or more desorbed components to the sweep gas heater.

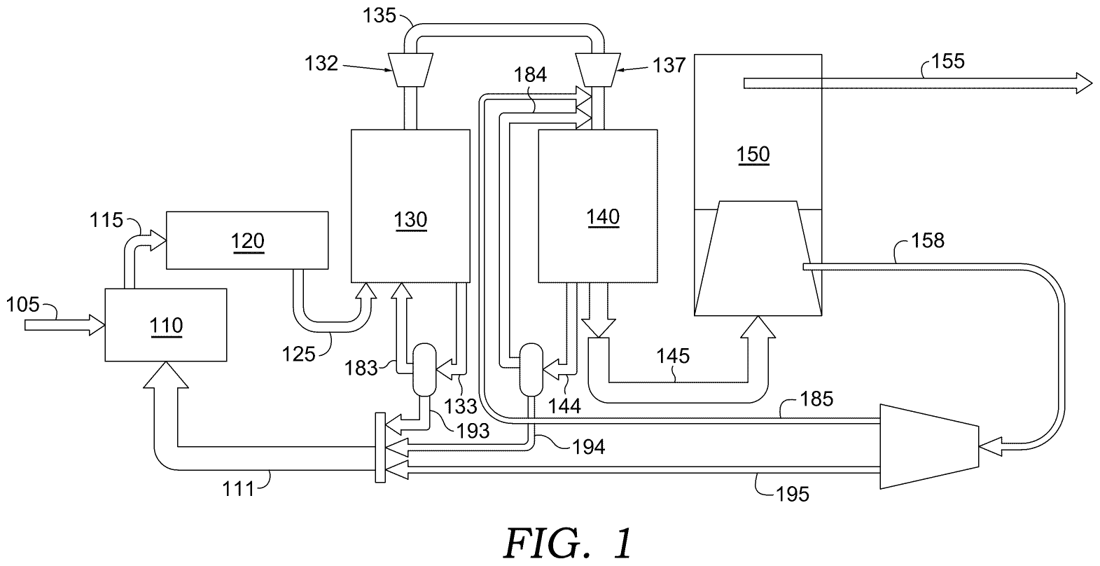

FIG. 1 shows an example of a configuration for a sweep gas separation system. In FIG. 1, make-up liquid 105 of an organic component is passed into sweep gas heater 110. Sweep gas heater 110 forms a vapor phase of the sweep gas, which is then used to make sweep gas flow 115. Sweep gas flow 115 is passed into sorbent environment 120 for desorption of one or more components from at least one sorbent bed (not shown) in the sorbent environment 120. This produces a desorption effluent 125 that contains the non-aqueous component (and/or other sweep gas components) along with one or more desorbed components. Desorption effluent 125 is passed into first separation stage 130. In the example shown in FIG. 1, separation stage 130 performs a separation in part by reducing the temperature in the separation stage 130 to a temperature below the temperature of sweep gas heater 120. This results in formation of intermediate effluent 135 and condensation effluent 133. In the example shown in FIG. 1, condensation effluent 133 can undergo a further gas-liquid separation to form first stage recycle stream 183 and first liquid recycle portion 193. First stage recycle stream 183, which primarily corresponds to desorbed components that were entrained with condensation effluent 133, is recycled back to first separation stage 130.

Intermediate effluent 135 is passed into second separation stage 140. In the example shown in FIG. 1, separation stage 140 performs a separation in part by increasing the pressure in the separation stage 140. In aspects where desorption effluent 125 exits from the sorbent environment at a pressure below ambient, the increase in pressure in the second separation stage can correspond to an increase in pressure to a pressure of roughly ambient or higher. In other aspects, the increase in pressure can provide a sufficient pressure increase to allow for additional condensation of the sweep gas. For example, a pump 132 and a compressor 137 can be used to pass intermediate effluent 135 into separation stage 140 at an increased pressure. Separation stage 140 produces a second intermediate effluent 145 and a second condensation effluent 144. In the example shown in FIG. 1, condensation effluent 144 can undergo a further gas-liquid separation to form second stage recycle stream 184 and second liquid recycle portion 194. Second stage recycle stream 184, which primarily corresponds to desorbed components that were entrained with condensation effluent 144, is recycled back to second separation stage 140.

Second intermediate effluent 145 is passed into compression stage 150. Compression stage 150 compresses the second intermediate effluent 145 to a pressure between 2.0 MPa-a and 5.0 Mpa-a. The substantial increase in pressure results in condensation of most of the remaining sweep gas that is mixed with the one or more desorbed components. Compression stage 150 generates a compressed effluent 155 that corresponds to the product stream of the desorbed components. For example, if the desorbed component is CO₂, compressed effluent 155 corresponds to a compressed stream of CO₂ that is ready for further processing, such as additional compression prior to transport or storage. Compression stage 150 also generates a compressed condensation effluent 158 that contains a majority of the non-aqueous component that was introduced into compression stage 150 as part of second intermediate effluent 145. The compressed condensation effluent can be decompressed to roughly ambient pressure, which allows for an effect similar to a gas-liquid separator. The resulting gas phase 185 can be recycled to second separation stage 140. A third liquid recycle stream 195 is also produced.

The first liquid recycle stream 193, second liquid recycle stream 194, and third liquid recycle stream 195 can then be returned 111 to sweep gas heater 110, optionally after pressure adjustment so that the liquid recycle streams are at an appropriate pressure.

In FIG. 1, vessels that are in fluid communication can either have direct fluid communication or indirect fluid communication. For example, sweep gas heater 110 is in direct fluid communication with sorbent environment 120. Sweep gas heater 110 is in indirect fluid communication with first separation stage 130, as the fluid communication is via sorbent environment 120.

### Process Cycle and Conditions—Sorption and Desorption

In various aspects, sorption and desorption of a component from a gas flow can be performed under low temperature, low pressure conditions. An example of a component that can be sorbed from a gas flow is CO₂. In such aspects, an amine-based sorbent is an example of a suitable sorbent.

A sorption/desorption cycle can include a series of steps. As an example, a sorbent can be located in a sorbent environment. One type of step that is always included is a sorption step, where the sorbent is exposed to a gas so that one or more components in the gas can be sorbed by the sorbent. In various aspects, during a sorption step, sorption (such as absorption or adsorption) of gas component can be performed at a temperature in the sorbent environment between −10° C. to 45° C., or −10° C. to 35° C., or −10° C. to 25° C., or −10° C. to 15° C., or 0° C. to 45° C., or 0° C. to 35° C., or 0° C. to 25° C. The temperature in a sorbent environment during a sorption step can be characterized based on measuring the temperature of the gas exiting from the sorbent environment at the end of the sorption step. It is noted that the temperature in a sorbent environment may vary during a sorption step and/or a desorption step. Depending on the aspect, the sorption step can be performed at roughly ambient pressure, or at a pressure greater than ambient. In various aspects, the pressure in the sorbent environment during the sorption step can be 90 kPa-a to 500 kPa-a, or 90 kPa-a to 150 kPa-a, or 90 kPa-a to 120 kPa-a, or 100 kPa-a to 500 kPa-a, or 100 kPa-a to 150 kPa-a, or 150 kPa-a to 500 kPa-a. The pressure in the sorbent environment during the sorption step can be characterized based on the pressure of the gas exiting from the sorbent environment.

Another type of step that is always present is a desorption step. During a desorption step, desorption of a sorbed component can be performed at a temperature in the sorbent environment between 20° C. to 70° C., or 20° C. to 50° C., or 20° C. to 40° C., or 35° C. to 70° C. In some alternative aspects where the sweep gas corresponds to an aqueous-based sweep gas, the temperature in the sorbent environment can potentially be higher, such as 20° C. to 100° C., or 20° C. to 70° C., or 20° C. to 50° C., or 35° C. to 100° C., or 35° C. to 70° C. The temperature in a sorbent environment during a desorption step can be measured based on the temperature of the gas exiting from the sorbent environment at the end of the desorption step. In addition to higher temperature, in some aspects desorption of a sorbed component can be facilitated by performing desorption at a lower pressure than the sorption step. In various aspects, the pressure during the desorption step can be 3.0 kPa-a to 150 kPa-a, or 3.0 kPa-a to 110 kPa-a, or 10 kPa-a to 150 kPa-a, or 30 kPa-a to 150 kPa-a, or 50 kPa-a to 150 kP-a, or 10 kPa-a to 110 kPa-a, or 30 kPa-a to 110 kPa-a, or 50 kPa-a to 110 kPa-a. In some aspects, the pressure during desorption can correspond to a pressure below ambient. In such aspects, the pressure during desorption can be 3.0 kPa-a to 90 kPa-a, or 3.0 kPa-a to 70 kPa-a, or 3.0 kPa-a to 50 kPa-a, or 10 kPa-a to 90 kPa-a, or 10 kPa-a to 70 kPa-a, or 10 kPa-a to 50 kPa-a, or 30 kPa-a to 90 kPa-a, or 30 kPa-a to 70 kPa-a, or 50 kPa-a to 90 kPa-a, or 50 kPa-a to 70 kPa-a. In other aspects, the pressure during desorption can be roughly ambient or higher. In such aspects, the pressure during desorption can be 90 kPa-a to 150 kPa-a, or 110 kPa-a to 150 kPa-a.

Typically, the temperature during desorption will be different from the temperature during sorption. The pressure in the sorbent environment can also vary between sorption and desorption. Thus, some type of temperature adjustment and/or pressure adjustment can be performed after the sorption step, and another temperature adjustment and/or pressure adjustment can be performed after the desorption step. In some aspects, temperature adjustment between the sorption step and desorption step can be performed using the sweep gas for desorption as a heat transfer medium. In such aspects, the temperature at the beginning of the desorption step may be lower than the temperature at the end of the desorption step, as some time may be required for the sorbent environment to heat to the temperature of the sweep gas. In other aspects, heat exchange pipes can be incorporated into the sorbent environment, so that water (or another heat exchange fluid) at an appropriate temperature can be flowed into the pipes in the sorbent environment as a heat exchange fluid. For pressure adjustment, pressure decreases can be performed using a suitable pump, while pressure increases can be performed by flowing a gas at the target pressure into the sorbent environment until roughly the target pressure is reached.

In addition to optional temperature and/or pressure adjustment steps, purge steps can also optionally be incorporated into a sorption/desorption cycle. Purge steps can assist, for example, with maintaining separation between sorption and desorption, in order to improve purity of the effluent from the desorption step.

The cycle length for a sorption/desorption cycle can vary depending on a variety of factors. For input flows with relatively higher concentrations of a gas component for sorption, shorter cycle lengths for the sorption step can be appropriate, such as a sorption step length of 5.0 seconds to 60 minutes, or 5.0 seconds to 10 minutes, or 5.0 seconds to 1.0 minutes, or 1.0 minutes to 60 minutes, or 1.0 minutes to 10 minutes, or 10 minutes to 60 minutes. For sorption from a more dilute input flow where the gas component for sorption is present at a concentration of 100 vppm to 2500 vppm, or 100 vppm to 1000 vppm, such as sorption of CO₂ from air, longer sorption steps can be used to allow a greater percentage of the equilibrium capacity of the amine to be utilized. For the desorption step, the desorption step length can be 5.0 seconds to 100 minutes, or 5.0 seconds to 10 minutes, or 5.0 seconds to 1.0 minutes, or 1.0 minutes to 100 minutes, or 1.0 minutes to 10 minutes, or 10 minutes to 100 minutes.

As an example of a sorption/desorption cycle, a sorbent environment can be used with an amine-based sorbent that is suitable for low temperature, low pressure operation. During the sorption step, an input flow of air can be passed into the sorbent environment for sorption of CO₂ from the air. The concentration of CO₂ (the component gas to be sorbed) in air is roughly 400 vppm. In this illustrative example, the air can be exposed to the sorbent at roughly ambient pressure and a temperature of −10° C. to 25° C. for roughly 30 mins. The air flow is then stopped, and the pressure in the sorbent environment is reduced to the target pressure for desorption, such as roughly 25-30 kPa-a, which also evacuates residual air from the bed. The sorbent environment can then be purged with methanol vapor from a sweep gas heater that is at a temperature of roughly 35° C., so that the sweep gas heater can provide a stream of methanol vapor at a pressure of roughly 30 kPa-a. The purging also increases the temperature of the sorbent environment. The methanol flow continues as desorption is performed using the methanol sweep gas for a target period of time and/or until the amount of CO₂ in the desorption effluent is reduced to a target level. During desorption, the temperature of the sorbent environment increases to roughly match the temperature of the sweep gas heater. After desorption, any remaining methanol can be purged, followed by decreasing the temperature back to −10° C. to 25° C. and increasing the pressure back to roughly ambient in order to start the next adsorption step. It is noted that other combinations of temperature and pressure can be used during sorption and desorption, depending on the nature of the sorbent.

### Amine Sorbents

In order to perform a sorption/desorption cycle at reduced temperature and pressure, the sorbent material in the sorbent environment needs to be a sorbent that provides reasonable working capacity for sorption/desorption of a component in the target temperature range. In some aspects, amine-based sorbents can be used to provide working capacity for a sorption/desorption cycle while maintaining a maximum temperature in the sorbent environment during desorption of 80° C. or less, or 70° C. or less, or 60° C. or less, such as down to a maximum temperature in the sorbent environment during desorption of 45° C. or possibly still lower.

For a CO₂ sorption desorption cycle, one example of an amine that provides suitable working capacity is tetraethylenepentamine (TEPA), which can absorb CO₂ at roughly 25° C. and regenerate (desorb) at roughly 70° C. or higher. Other examples are 2-methoxy-n-methylbenzene (MMBA) and N,N-Bis[3-(methylamino)propyl]methylamine (BMMA), which both can absorb CO₂ at temperatures between −10° C. and 25° C. while allowing for regeneration at temperatures between 25° C. and 50° C. In other aspects, amines that can be used include secondary amines that a) have a melting point and/or glass transition temperature that is below the sorption temperature (i.e., the secondary amine is a liquid at the sorption temperature), and b) have a vapor pressure of 0.02 kPa or less at 25° C.

It is noted all of the above amines correspond to amines that are liquids in the temperature range where the sorption/desorption cycle occurs. However, in order to provide high contact area, it is beneficial to have high surface area solid sorbents. In order to obtain the favorable working temperature range of the amines while still providing a high surface area solid sorbent, a sorbent can be formed that corresponds to a solid with infused reactive liquids (SWIRL). By infusing an amine into a solid structure, a sorbent can be performed that provides the beneficial sorption/desorption properties of the liquid amine while also providing the higher surface areas that can be achieved by the solid support of the liquid.

In a SWIRL type sorbent structure, the infused liquid can correspond to an amine-based sorbent, such as to molecular compounds containing primary amines (R—NH₂), secondary amines (R—NH—R′), tertiary amines (R—N—R′), or mixtures of them. In some aspects involving direct air capture, a high concentration of secondary amine compounds in the liquid can be beneficial. Depending on the amine type, absorption and regeneration are typically performed at different temperatures, similar to existing solid sorbent technologies. However, some SWIRL type sorbent structures can allow for sorption/desorption cycles with substantially reduced temperatures during sorption and desorption and/or temperature differentials between sorption and desorption. For example, a SWIRL-TEPA sorbent (SWIRL with infused tetraethylenepentamine as the amine-based sorbent) can absorb CO₂ at Tₐ=25° C. while being regenerated at Tᵣ=70° C. Some other amine liquids (such as MMBA and BMMA) can absorb CO₂ at Tₐ=(−10-25) ° C. and be regenerated at Tᵣ=25° C. or higher. It has been discovered that reducing the operating temperature and magnitude of the temperature swing between absorption and regeneration yields a significant reduction of the thermal energy requirements. This is significant as thermal costs can account for up to 80% of the overall operating energy consumption of a DAC facility. Another potential benefit of using low desorption temperatures is a reduced or minimized oxidation rate. In current solid sorbent technologies, residual air has to be removed with a vacuum pump between the absorption and regeneration stages to prevent oxidation while the monoliths are heated up to the regeneration temperature of 80° C. or higher. For SWIRL-amine structures that can desorb at 70° C. or less, amine oxidation is significantly reduced. For example, SWIRL-MMBA (SWIRL with infused 2-methoxy-n-methylbenzylamine) and SWIRL-BMMA (SWIRL with infused N,N-Bis[3-(methylamino)propyl]methylamine) can both be operated between −10° C. to 25° C. Such low temperature swings can also reduce, minimize, or even eliminate the need of having a vacuum pump for residual air removal.

### Sorbents Based on SWIRL

In various aspects, amine-based sorbents having a structure of a solid with infused reactive liquids (SWIRL) can be used for sorption/desorption cycles, such as sorption/desorption cycles performed with desorption temperatures of roughly 70° C. or less. It is noted that sorbents based on a SWIRL design, including amine-based sorbents based on a SWIRL design, are not necessarily limited to use only in low temperature, low pressure environments. For example, a SWIRL structure with TEPA as the supported amine liquid (SWIRL-TEPA) can potentially be used in sorption/desorption cycles with desorption temperatures of 70° C. or higher so that steam can be used (if desired) as the sweep gas for desorption.

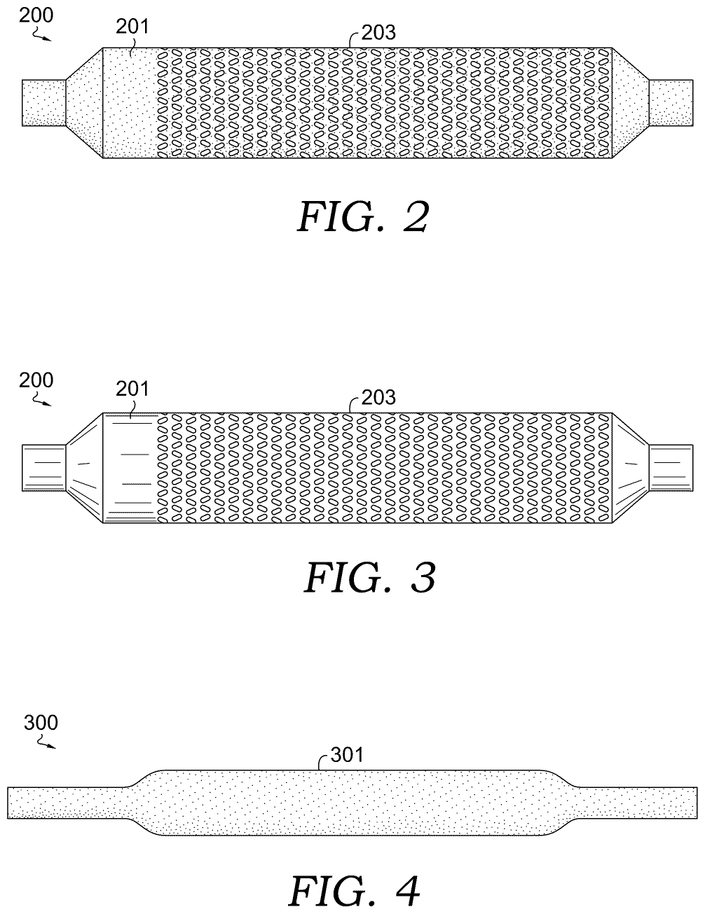

FIGS. 2-4 show examples of a structure that can be used to form a solid with infused reactive liquid structure. Referring to FIG. 2 and FIG. 3, a species extraction apparatus 200 can include a body 201 supporting a matrix structure 203. The matrix structure 203 comprises a plurality of surfaces that function to enhance uptake of the absorptive liquid and provide a complex, tortuous flow path for the working fluid. These features increase contact between the absorptive liquid and working fluid that is passed through the apparatus, and thus improve the efficiency of the species extraction apparatus 200.

In certain embodiments, the absorptive liquid is infused within at least a portion of the texture of the species extraction apparatus 200. This is referred to herein as a liquid infused surface, infused liquid, or the like. When the absorptive liquid covers the entire top surfaces of the textures, it is referred herein to as a liquid encapsulated solid, encapsulation, or the like. Both a liquid infused surface and a liquid encapsulated solid may be referred to herein as a liquid impregnated solid.

As shown in FIG. 2 and FIG. 3, the matrix structure 203 can be externally accessible. In other embodiments as shown in FIG. 4, the species extraction contactor 300 can contain the matrix structure within the body 301 such that it is only accessible internally. For example, as shown, the body 301 can form a pipe with an outer shell for channeling flow through the pipe. The outer shell can provide one or more benefits, in addition to the ease of operation, as no assembly is required when the entire structure is manufactured as one. For example, a tortuous path combined with the outer shell may greatly reduce potential bypass issues as no additional wrapping or loading of the cellular structure into a reactor or tube is required. Also, the contact of the cellular structure to the shell of the body 301 can provide a direct path for the conduction of heat that could be utilized to desorb the absorbed gas species from the supported absorptive liquid. Additionally, both the shell as well as the inside matrix structure are capable of providing the characteristics of a support structure for a liquid impregnated solid.

The species extraction apparatuses 200 and 300 can be configured to uptake an absorptive liquid disposed on the matrix structures. The absorptive liquid can be configured to remove at least one species from a working fluid that contacts the matrix structures. For example, embodiments can include suitable internal and external surface roughness, textures, or structural features to uptake a suitable amount of absorptive liquid (e.g., to produce CO₂ absorption in accordance with the tables below).

In some embodiments, the performance index (PI) of the apparatus is greater than 150.0 m⁻¹ or greater than 500.0 m⁻¹. PI is defined as PI=(V1/V)(A1/V). V1 and A1 are the volume and surface area of the impregnating/absorptive liquid, respectively. V1 may be determined by weighing the apparatus before and after applying the absorptive liquid, and then converting the mass difference (e.g., the mass of absorptive liquid held by the apparatus) into a volume using the density of the absorptive fluid. Where the absorptive liquid perfectly or nearly-perfectly wets all of the surfaces of the apparatus, A1 is essentially equal to S, the surface area of the apparatus. In such cases, S is substituted for A1 in the calculation of PI for simplicity. For purposes of the PI calculation herein, perfect or near-perfect wetting is presumed and thus S is used for A1 in the calculation of PI. The amount of absorptive liquid that the apparatuses disclosed herein uptake suggests that this assumption is reasonable. Systems with a PI greater than 150 m⁻¹ are more efficient, and thus can be smaller and less expensive than conventional systems.

Certain embodiments can include a surface treatment configured to chemically activate the surface to cause interaction with and/or wetting of the surface by the selected absorptive liquid. Any suitable chemical surface treatment or other treatment to cause wetting of the surface by the absorptive liquid is contemplated herein. Such an activated surface can greatly enhance uptake of the absorptive liquid.

In certain embodiments, the apparatus has a surface area to volume (S/V) ratio of greater than about 180 m⁻¹. In certain embodiments, the S/V ratio can be between 2500 m⁻¹ and 12500 m¹.

In some aspects, the apparatus may include a plurality of cellular units, such as hex prism laves phase units, to form the matrix structure. For example, a plurality of cellular units can be formed in a vertical stack and/or formed next to each other laterally. Such cellular units can be stacked and/or placed adjacent to each other in any suitable manner. Any other suitable shape for the matrix structure is contemplated herein.

The matrix structure can be pretreated. For example, it may be calcined in air for a predetermined time and temperature. The matrix support structure can be calcined in air or other suitable fluid, at a temperature of above 150° C., above 250° C., or above 350° C. before the absorptive liquid is disposed thereon. This has been found to increase the uptake and performance of the absorptive liquid and thus improve the efficiency of absorption of the working fluid.

The apparatus can be made out of metal. Any other material suitable for the desired application is contemplated herein (e.g., ceramics, plastics). Additively manufacturing can include selective laser sintering (e.g., a metallic powder) at an energy density less than roughly 5.0 J/mm to increase roughness of the metallic body. The apparatus can be formed by additive manufacturing or “3D printing”. Any suitable 3D printing process can be used.

### Example 1—Comparison of Amine Sorbents

Table 1 shows a comparison of the CO₂ sorption and desorption properties of several commonly used amines relative to amines that can be used in a low temperature, low pressure sorption/desorption cycle. In Table 1, the first two rows correspond to conventional amine sorbents that have been reported in the literature. The third row corresponds to reported values for a metal-organic framework (MOF) type sorbent. The final two rows correspond to SWIRL-amine sorbents that can be used under low temperature, low pressure sorption/desorption conditions.

In Table 1, Ta is the temperature for performing an adsorption step, Tr is the temperature for performing a regeneration (desorption) step, and ΔTra is the difference between the temperatures for adsorption and regeneration. CO₂ loading refers to the rate of loading for the sorbent under direct air capture conditions.

TABLE 1
Sorption and Desorption Properties for CO₂ Sorbents

| | Tₐ | Tᵣ | ΔTᵣₐ | CO₂ loading [(mol |
|---|---|---|---|---|
| Technology | [° C.] | [° C.] | [° C.] | CO₂)/(min m³)] |
| Cellulosic amine mesopores | 25 | 80-120 | 65-95 | 2-4 |
| Polymer-amine mesopores | 25 | 105-130 | 80-105 | 2-4 |
| Cr-MIL-101 MOF | 25 | 100 | 75 | 3.5 |
| SWIRL-TEPA | 20-50 | 70-80 | 20-60 | >10 |
| SWIRL-MMBA & SWIRL-BMMA | −5-25 | 25-50 | 0-55 | >10 |

As shown in Table 1, the conventional amine sorbents in the first two rows require desorption temperatures of 80° C. or more while only having a loading rate of 2-4 (mol CO₂)/(min m³). Similarly, the conventional MOF sorbent shown in the third row requires a desorption temperature of greater than 80° C. while having a loading rate of 3.5 (mol CO₂)/(min m³). By contrast, the amine-based SWIRL sorbents in the final two rows of Table 1 have more favorable characteristics. The temperature differential between sorption and desorption is reduced, while the loading rate is greater than 10 (mol CO₂)/(min m³).

Based on Table 1, the amine-based SWIRL sorbents can provide loading rates that are several times that the loading rates for the other reported technologies. This implies that—at the same cycle time—the bed size could be reduced by an order of magnitude, reducing the capital/installation costs associated with the bed by about the same factor. It is noted that capital/installation costs for a sorbent bed are often the largest contributor to the overall costs for a direct air capture technology.

### Example 2—CO₂ Loading Rates During a Sorption and Desorption Cycle

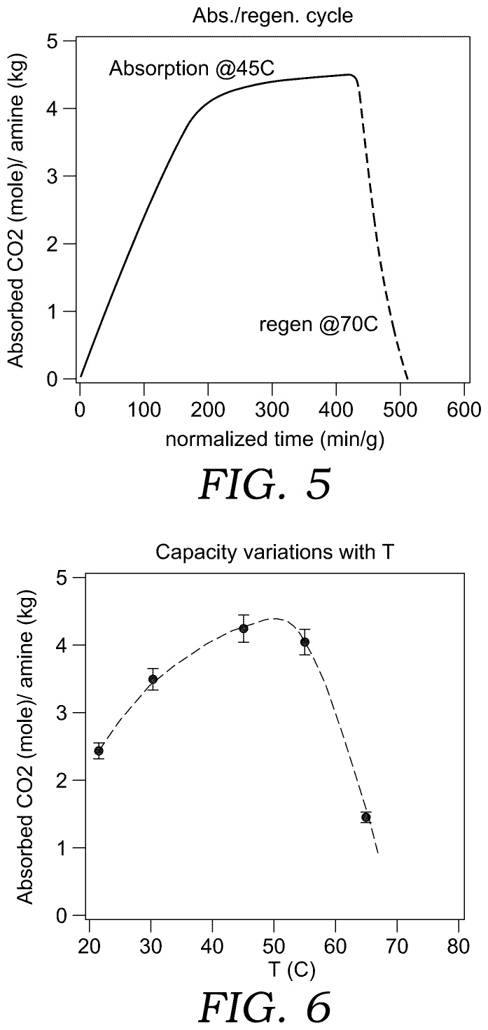

FIG. 5 and FIG. 6 show various properties related to CO₂ sorption and desorption for an amine-based SWIRL sorbent corresponding to tetraethylenepentamine infused on a support substrate, such as the support show in FIG. 2 or FIG. 3. This is an example of a SWIRL-TEPA sorbent. FIG. 5 shows an example of an absorption and regeneration (desorption) cycle for the SWIRL-TEPA sorbent under direct air capture conditions, including a CO₂ concentration of roughly 400 vppm. In FIG. 5, the horizontal axis corresponds to a “normalized time” corresponding to minutes per gram of amine sorbent. Use of this “normalized time” allows sorption from beds of with different amounts of amines to be compared. As shown in FIG. 5, the TEPA supported on a high surface area solid can adsorb CO₂ at 45° C. to achieve 80% or more of a maximum loading in a relatively fast manner, and can also rapidly desorb at 70° C. FIG. 6 shows how the maximum capacity during adsorption varies with temperature for the example of SWIRL-TEPA shown in FIG. 5.

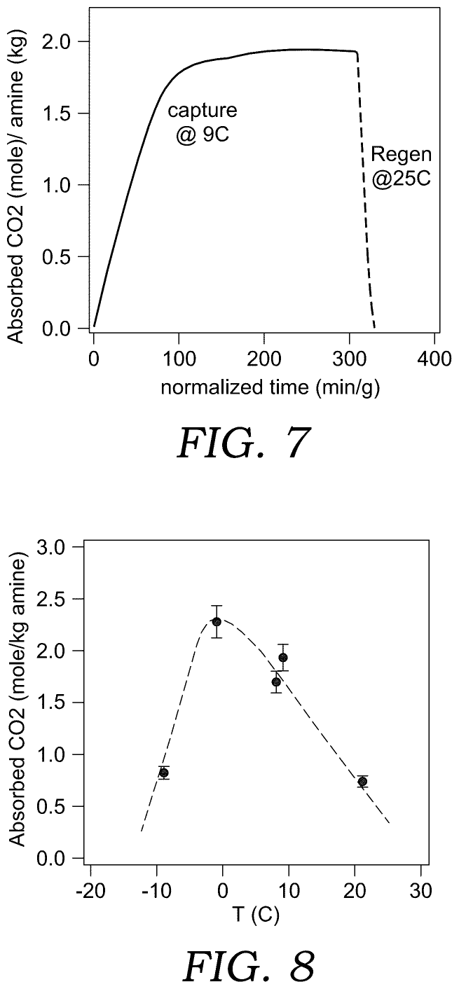

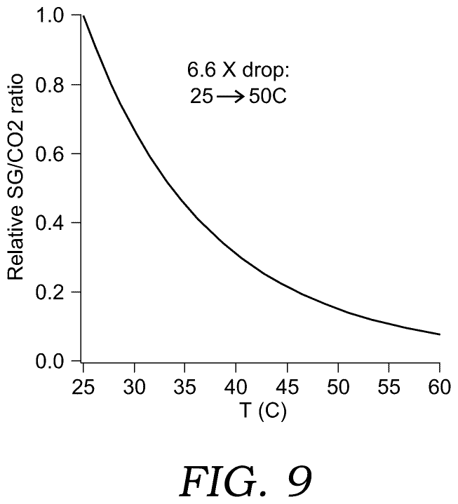

FIGS. 7 and 8 provide similar types of information for a support structure similar to the support used in FIGS. 5 and 6 but infused 2-methoxy-n-methylbenzylamine (MMBA). This is an example of a SWIRL-MMBA sorbent. FIG. 7 shows an example of an absorption and regeneration (desorption) cycle for the SWIRL-MMBA sorbent under direct air capture conditions, including a CO₂ concentration of roughly 400 vppm. As shown in FIG. 7, the MMBA supported on a high surface area solid can adsorb CO₂ at 9° C. to achieve 80% or more of a maximum loading in a relatively fast manner, and can also rapidly desorb at 25° C. FIG. 8 shows how the maximum capacity during adsorption varies with temperature for the example of SWIRL-MMBA shown in FIG. 7. It is noted that the SWIRL-MMBA sorbent for FIGS. 7 and 8 actually has a maximum capacity for CO₂ that is at or below 0° C. Due to practical difficulties with managing water precipitation and/or freezing, temperatures above 0° C. may be simpler to use, but some benefits could be realized from operating at temperatures at or below 0° C. for a sorbent system such as a SWIRL-MMBA system.

### Example 3—Methanol Sweep Gas Recovery

A configuration similar to the example configuration shown in FIG. 1 can be used for recovery of methanol sweep gas when performing a CO₂ sorption/desorption cycle under low temperature conditions. In this example, only the regeneration (desorption) step of a sorption/desorption cycle is illustrated. Instead, this example focuses on the purification of the CO₂ stream and the recovery of the sweep gas used in the desorption step.

In this example, regeneration is carried out by a combination of mild heating and sweeping using a low boiling point (BP) sweeping gas (SG). There are multiple options for such low temperature regeneration processes. The configuration shown in FIG. 1 is an example of a configuration that can perform a low temperature regeneration. For the example shown in FIG. 1, there are four separate stages for the methanol sweep gas stream, with the methanol sweep gas being mixed with various amounts of CO₂ depending on the stage. In the sweep gas heater 110 (such as a boiler), methanol (or another sweep gas) is generated at a pressure determined by available heat sources. For example, methanol (MeOH with BP 65° C.) can be used as the liquid for forming the sweep gas (the “sweep liquid”) in the sweep gas heater 110. When heated to 35° C. methanol vapor at 300 mbar is generated, based on methanol vapor-liquid equilibrium data. Such temperatures could be achieved at low cost in tropical geographical regions using surface sea water as a heat exchange fluid. More generally, various types of water sources can be used as heat exchange fluids for either heating or cooling, such as sea water (surface or from various depths, water from a fresh water source (e.g., water from a lake or river), or another convenient water source. At colder climate regions one may use heat pumps, or low-grade geothermal heat (<90° C.). Still another potential source of a heat exchange fluid can be a fluid provided from another type of processing plant, such as a heat exchange fluid provided from a liquefied natural gas processing plant. More generally, any other convenient option can be used for providing heat to boiler 110 to generate a vapor phase of methanol (or another sweep liquid).

If the methanol vapor pressure is below ambient, the methanol can be pulled with a vacuum pump (e.g., a liquid ring pump) from the sweep gas heater 110 through the sorbent bed 120 to desorb CO₂ and regenerate the sorbent bed. In an example using methanol as the sweep gas, the desorption effluent will be a mixture of SG and CO₂ with a molar ratio of 5:1 or higher. In this example, the desorption effluent then enters condenser 130 (first separation stage) which is held at substantially the same pressure, however, at a temperature that is lower than the temperature in the boiler or sweep gas heater by at least 15° C. In this step the majority of the methanol (and/or other sweep gas) condenses out and the molar ratio of methanol to CO₂ reaches parity or is reversed. In some aspects, the molar ratio of methanol (and/or other sweep gas) to CO₂ can be roughly 0.1 in the effluent from the condenser 130. After the condenser 130, a vacuum pump 132 (such as a liquid ring pump) and/or a compressor 137 can be used to pull the effluent from the first separation stage into the second separation stage 140 while also increasing the gas pressure to roughly ambient. In this example, this increase in pressure is performed while maintaining the temperature in the second separation stage 140 at substantially the same temperature as in condenser 130. Since the equilibrium vapor pressure of the methanol (and/or other sweep gas) does not change, the composition of the gas will be shifted towards higher CO₂ concentration (increased partial pressure of CO₂) due to condensation of the methanol. The ratio of SG to CO₂ in this example is hence reduced further to a molar ratio having an order of magnitude of roughly 0.01. The gas mixture in this example now consists mainly of CO₂ and can be compressed to roughly 30 bar (well below CO₂ condensation) using a compression train (compression stage 150). Since the temperature is maintained at a temperature similar to the second separation stage 140, the gas pressure is mainly carried by CO₂, which further reduces the molar ratio of methanol (and/or other sweep gas) to CO₂ ratio to a value having an order of magnitude of roughly 0.001. This implies a CO₂ purity level of >99% and a minimal loss of methanol as part of the CO₂ product stream 155. Note that compression stage 150 does not exhibit an addition to the overall DAC process compared to other carbon capture storage technologies, since CO₂ will be further compressed to 70 bar or higher for storage.

The methanol (and/or other sweep gas) stream needs to be recycled for all three of the separation stages. The recycled liquid will contain some dissolved CO₂, with the highest concentration after compression stage 150 and the lowest after first separation stage 130. However, since the vast majority of methanol condenses in first separation stage 130, the overall recycled methanol stream will have a low concentration of CO₂, before it re-enters the sweep gas heater 110. For direct air capture, the CO₂ mole fraction in the recycle stream 111 should be in the range of only a few hundred ppm or lower. It is therefore beneficial to choose a non-aqueous component such as methanol with low CO₂ solubility as the sweep gas.

### Example 4—Additional Examples of Methanol as Sweep Gas

Steady state process simulations were performed using a commercial software package to illustrate two sets of operating conditions for a sweep gas recovery system similar to the configuration shown in FIG. 1 where methanol is used as the sweep gas. It is noted that that other sweep gas fluids can be used as long as a) the CO₂ purity in the final compression stage, such as compression stage 150, is high (e.g., greater than 95 vol %), b) the loss of the sweep gas in the resulting CO₂ product is economically acceptable, and c) the CO₂ concentration in the recycled stream is on the order of two hundred ppm or less. Methanol has multiple advantages over water. For example, the boiling point of methanol is 65° C., enabling a sufficiently high vapor pressure even at roughly ambient temperature. The sensible and latent heat of methanol is lower than that of water, making vapor generation more energy efficient compared to steam. CO₂ solubility in methanol is higher than that in water. However, with a mole fraction of only 0.5% at p_{CO2}=1 bar and 25° C., methanol contains one of the lowest CO₂ levels among non-aqueous solvents. Due to the low molecular weight of methanol and abundancy as a commodity product, the material loss of MeOH and the entailing costs can be minimal.

Table 2 shows gas compositions in the various stages in FIG. 1. Two scenarios have been simulated with a temperature in the sorbent environment 120 during adsorption of 10° C.

TABLE 2
Simulated Stream Compositions

| | Sorbent | 1^{st} separation | 2^{nd} separation | Compression |
|---|---|---|---|---|
| | bed 120 | stage 130 | stage 140 | stage 150 |
| Scenario 1 | | | | |
| T (° C.) | 25 | 10 | 10 | 10 |
| P (bar) | 0.17 | 0.14 | 1 | 30 |
| SG:CO₂ | 10 | 1.17 | 0.08 | 0.003 |
| (mol/mol) | | | | |
| Scenario 2 | | | | |
| T (° C.) | 48 | 10 | 10 | 10 |
| P (bar) | 0.55 | 0.52 | 1 | 30 |
| SG:CO₂ | 5 | 0.17 | 0.08 | 0.03 |
| (mol/mol) | | | | |

In addition to the values shown in Table 2, for Scenario 1, the CO₂ product stream 155 included 0.21 wt % of methanol, while the recycle stream 111 included 110 vppm of CO₂. For Scenario 2, the CO₂ product stream 155 included 0.25 wt % of methanol, while the recycle stream 111 included 126 vppm of CO₂.

In the Scenario 1, seawater is used to heat MeOH to 25° C. and generate a sweep gas (SG) for regeneration of amine. A SG:CO₂ molar ratio of 10 is assumed when the stream exits the sorbent environment 120. Such a scenario could be deployed in warm, tropical regions near the coast. Seawater in equatorial regions has a temperature of around 10° C. at a depth of ˜500 m and could be used for temperature control during absorption and for the SG condensation steps. Heat from air or from surface seawater in tropical regions with average temperature of 30° C. could be used during the amine regeneration at 25° C. At this temperature the methanol vapor pressure is only 140 mbar, which facilitates desorption of CO₂. As the stream is processed through the various stages the SG:CO₂ ratio decreases and is finally reversed, with the main reduction of SG happening in the condenser or first separation stage 130. The CO₂ stream is further purified by further condensation in stages 140 and 150. In compression stage 150, the gas is compressed to 30 bar and the final methanol concentration reaches ppm level, corresponding to a CO₂ purity level of 99.8 wt %. The CO₂ stream can now be further compressed to storage conditions. The condensed methanol streams separated in stages 130, 140, and 150 are recycled 111 and fed back into the boiler 110. It is noted that there is a small concentration of CO₂ (110 ppm) that will be mixed in the sweeping gas stream before it reenters the SWIRL bed. Based on separate experimental data, it has been determined that even a 400 ppm CO₂ level in the sweeping gas stream does not adversely affect regeneration. This is mainly due to vacuum conditions and due to an increased temperature, as the regeneration temperature is 15° C. higher than the absorption temperature in Scenario 1.

In Scenario 2, the absorption temperature is kept at 10° C., but amine regeneration is carried out at 48° C. Since the temperature is higher than in Scenario 1, the SG:CO₂ ratio is reduced from 10 to 5. The types of conditions used in Scenario 2 can be deployed, for example, in colder coastal regions where a temperature of 10° C. is present on the water surface, or only a few meters beneath. Waste heat from geothermal or from industrial sources could be used to heat methanol to −50° C. This regeneration temperature requires less heat than what is typically needed to generate steam. At 50° C. the MeOH vapor pressure is 550 mbar in the boiler 110 and the sorbent environment 120. As shown in Table 2, the molar ratio of sweep gas to CO₂ is reversed as the gas stream (MeOH vapor mixed with desorbed CO₂) moves through the various condensation steps 130, 140, and 150. At the outlet the CO₂ stream is purified to >99.8 wt %, as in Scenario 1, and can be further processed for storage or utilization. Again, some CO₂ will be dissolved in liquid methanol that has been condensed during regeneration and recycled back. However, with proper separation the CO₂ concentration in the methanol recycle stream is about 130 ppm. As before, this is sufficiently low, even though the vacuum is not as low as in scenario 1. It is noted, however, that the regeneration temperature is 38° C. higher than the absorption temperature. The working capacity remains therefore high (˜2 mol/kg amine) and can be further improved with a high number density of secondary amine molecules.

Both Scenario 1 and Scenario 2 demonstrate that the proposed regeneration process using low boiling point gases, such as methanol, can be highly effective in reaching high purity levels of CO₂ and minimal loss of methanol (0.2-0.3 wt %). In order to compare the effectiveness of both scenarios, the required power was analyzed for the overall absorption and regeneration process. Table 3 lists the expected electric power requirements of major equipment needed for the overall absorption and regeneration stages. Heating and cooling duties are listed as well, even though they are “freely” available either by usage of seawater or other “free” low grade waste heat sources, such as those from existing geothermal power plants. One has, however, to account for seawater pumps as they need to deliver a significant amount of water to heat exchangers in the boiler and condensers. In the second scenario, in which the liquid flow rate is comparably small due to hot waste heat utilization (60-90° C.), the power consumption of the hot liquid pump is much smaller (<<0.1 MWₑ). The total electric energy need per ton of absorbed CO₂ is in the range of 370-670 kWh/t, which is in the same order of magnitude as other conventional technologies. The processes shown in Table 3, however, use “free” heat whereas the other conventional technologies typically require (3-8) GJ/t or (2.8-7.6) MMBtu/t heat generation.

TABLE 3
Power Consumption and Heating Duty

| | | Regeneration | | | | | | | |
|---|---|---|---|---|---|---|---|---|---|
| | Absorption | | | | | hot | cold | | total |
| | blower | boiler | condenser | vacuum | | seawater | seawater | total | energy in |
| | power | duty | duty | pumps | compressor | pumps | pump | electric | [kWh/(t |
| | [MWₑ] | [MW] | [MW] | [MWₑ] | [MWₑ] | [MWₑ] | [MWₑ] | [MWₑ] | of CO₂)] |
| Scenario 1 | 0.3* | 3.5 | 3.7 | 0.2 | 0.1 | 0.2 | 0.1 | 0.9 | 670 |
| | | (free) | (free) | | | | | | |
| Scenario 2 | 0.3* | 1.9 | 1.2 | 0.03 | 0.1 | <<0.1 | 0.1 | 0.5 | 372 |
| | | (free) | (free) | | | (geothermal) | | | |

As shown in Table 3, the temperature swing in Scenario 1 is moderate at 15° C. This entails a higher SG:CO₂ ratio, which in turn means a substantial amount of SG material needs to be piped for heating and cooling. To take advantage of this low temperature swing, abundant heat sources and sinks are required. Such abundant heat sources in the form of “free” heat are available in warm or hot regions around the equator, with access to cold water sources at 500 m depth for condensation.

Scenario 2 operates between 10° C. and 50° C. In cold coastal regions, surface water can be used for cooling sources. Although the heating is more significant in Scenario 2, going to 50° C. regeneration temperature reduces the SG:CO₂ ratio by a factor of two. This is further illustrated in FIG. 10. A temperature level of 50° C. could be provided by ‘low temperature geothermal resources’ (<90° C.). In this type of embodiment, waste heat from geothermal power plants can be fully utilized here without affecting the power production since brine is used after the steam turbine processing step and prior to re-injection into the ground. Some desalination processes can also potentially provide this type of waste heat. Alternatively, industrial processes (e.g. power plants) with large amounts of waste heat could be utilized in a similar fashion.

### Additional Embodiments—Sweep Gas Recovery

Embodiment 1. A method for recovering a sweep gas, comprising: heating a sweep liquid to a first temperature to form a sweep gas at a first vapor pressure, the first temperature being equal to or less than a boiling point for the sweep liquid at 100 kPa-a, the first temperature being 85° C. or less; exposing a sorbent bed in a sorbent environment to at least a portion of the sweep gas, at a sweep pressure in the sorbent environment of 90 kPa-a or less and a sweep temperature in the sorbent environment comprising the first temperature or higher, to form a desorption effluent comprising the sweep gas and at least one desorbed component, the sweep pressure comprising the first vapor pressure or lower; reducing the temperature of at least a portion of the desorption effluent to a temperature below the first temperature to form a first intermediate effluent enriched in the at least one desorbed component and a first condensed sweep liquid, a pressure during the reducing the temperature being 90 kPa-a or less; increasing the pressure of at least a portion of the first intermediate effluent to a pressure between 90 kPa-a and 200 kPa-a to form a second intermediate effluent and a second condensed sweep liquid; and compressing at least a portion of the second intermediate effluent to a pressure greater than 200 kPa-a to form a compressed condensed sweep liquid and a desorption product, wherein heating the sweep liquid comprises heating a) at least a portion of the first condensed sweep liquid, b) at least a portion of the second condensed sweep liquid, c) at least a portion of the compressed condensed sweep liquid, or d) a combination of two or more of a), b), and c).

Embodiment 2. The method of Embodiment 1, wherein a molar ratio of the sweep gas to the at least one desorbed component in the desorption effluent is greater than 1.0.

Embodiment 3. The method of any of the above embodiments, wherein a molar ratio of the sweep gas to the at least one desorbed component in the first intermediate effluent is less than 1.5.

Embodiment 4. The method of any of the above embodiments, wherein a molar ratio of the sweep gas to the at least one desorbed component in the second intermediate effluent is less than 0.1.

Embodiment 5. The method of any of the above embodiments, a) wherein the at least one desorbed component comprises CO₂; b) wherein the sweep liquid comprises methanol, ethanol, isopropyl alcohol, or a combination thereof; or c) a combination of a) and b).

Embodiment 6. The method of any of the above embodiments, wherein the sweep liquid comprises a boiling point at 100 kPa-a of 20° C. to 85° C.

Embodiment 7. The method of any of the above embodiments, wherein the second intermediate effluent, the at least a portion of the second intermediate effluent, or a combination thereof comprises a pressure of 90 kPa-a or more prior to the compressing.

Embodiment 8. The method of any of the above embodiments, wherein the second intermediate effluent, the at least a portion of the second intermediate effluent, or a combination thereof comprises a temperature below the first temperature.

Embodiment 9. The method of any of the above embodiments, wherein the first intermediate effluent, the at least a portion of the intermediate effluent, or a combination thereof comprises a pressure of 90 kPa-a or less.

Embodiment 10. The method of any of the above embodiments, wherein the desorption product comprises a pressure of 500 kPa-a or more.

Embodiment 11. The method of any of the above embodiments, further comprising combining the at least a portion of the first intermediate effluent with a recycle portion of the second intermediate effluent prior to the increasing the pressure of the at least a portion of the first intermediate effluent.

Embodiment 12. The method of any of the above embodiments, further comprising: decompressing the at least a portion of the compressed condensed sweep liquid to form a third condensed sweep liquid and a decompression gas comprising one or more desorbed components of the at least one desorbed component, and combining the at least a portion of the first intermediate effluent with a recycle portion of the decompression gas prior to the increasing the pressure of the at least a portion of the first intermediate effluent, wherein the at least a portion of the compressed condensed sweep liquid comprises the third condensed sweep liquid.

Embodiment 13. The method of any of the above embodiments, further comprising combining the at least a portion of the desorption effluent with a recycle portion of the first intermediate effluent prior to the decreasing the temperature of the at least a portion of the desorption effluent.

Embodiment 14. The method of any of the above embodiments, wherein heating the sweep liquid comprises heating a non-aqueous liquid.

Embodiment 15. The method of any of the above embodiments, wherein heating the sweep liquid comprises heating a carbon-containing liquid; or wherein heating the sweep liquid comprises heating an organic liquid.

Embodiment 16. A system for recovering a sweep gas, comprising: a sweep gas heating stage for heating a sweep liquid at a pressure of less than 90 kPa-a to form a sweep gas, the sweep gas heating stage comprising a liquid inlet, a recycle inlet, and a sweep gas outlet; a sorbent environment comprising a sorbent bed, the sorbent environment comprising a sorbent sweep gas inlet in fluid communication with the sweep gas outlet, and a desorption effluent outlet; a first condensation vessel comprising a first condensation vessel inlet in fluid communication with the desorption effluent outlet, a first condensation vessel gas outlet, and a first condensation vessel liquid outlet; a second condensation vessel comprising a second condensation vessel inlet in fluid communication with the first condensation vessel gas outlet, a second condensation vessel gas outlet, and a second condensation vessel liquid outlet; and a compression stage comprising a compressor inlet in fluid communication with the second condensation vessel gas outlet, a compression gas outlet, and a compression liquid outlet, wherein the recycle inlet is in fluid communication with at least one of the first condensation vessel liquid outlet, the second condensation vessel liquid outlet, and the compression liquid outlet.

Embodiment 17. The system of Embodiment 16, wherein the system further comprises a sweep gas reservoir in fluid communication with the liquid inlet, the sweep gas reservoir containing a carbon-containing sweep liquid having a boiling point at 100 kPa-a of 85° C. or less.

Embodiment 18. The system of Embodiment 16 or 17, wherein the sorbent bed comprises an amine sorbent, the sorbent bed optionally comprising a solid with infused reactive liquid.

Embodiment 19. The system of any of Embodiments 16 to 18, where at least one of the first condensation vessel and the second condensation vessel comprises a vessel capable of operating at a pressure of 90 kPa-a or less.

### Additional Embodiments—CO₂ Capture

Embodiment 1. A method for capturing CO₂, comprising: exposing a CO₂-containing gas to a sorbent bed in a sorbent environment under sorption conditions comprising a sorbent environment temperature of 30° C. or less to form a sorbent bed comprising sorbed CO₂ and a CO₂-depleted effluent; exposing the sorbent bed to a sweep gas under desorption conditions comprising a sorbent environment temperature of 70° C. or less to form a desorption effluent comprising at least a portion of the sorbed CO₂ and at least a portion of the sweep gas, the sweep gas comprising 80 mol % or more of one or more non-aqueous components having a boiling point between 20° C. and 85° C. at 100 kPa-a, a molar ratio of the one or more non-aqueous components to CO₂ in the desorption effluent being 1.0 or more; separating the desorption effluent to form a gas phase effluent comprising 90 mol % or more of CO₂ and one or more liquid phase fractions comprising 80 mol % or more of the one or more non-aqueous components; and heating at least a portion of the one or more liquid phase fractions to form at least a portion of the sweep gas.

Embodiment 2. The method of Embodiment 1, wherein the one or more non-aqueous components comprise methanol.

Embodiment 3. The method of any of the above embodiments, wherein the sorbent bed comprises an amine sorbent, the sorbent bed optionally comprising a solid with infused reactive liquid.

Embodiment 4. The method of Embodiment 3, wherein the amine sorbent comprises 2-methoxy-n-methylbenzylamine, N,N-Bis[3-(methylamino)propyl]methylamine, or a combination thereof.

Embodiment 5. The method of any of the above embodiment, wherein the partial pressure of the one or more non-aqueous components in the desorption conditions is 15 kPa-a or more.

Embodiment 6. The method of any of the above embodiments, wherein the desorption conditions comprise a sorbent environment pressure of 90 kPa-a or less, or wherein the desorption conditions comprise a sorbent environment pressure of 70 kPa-a or less.

Embodiment 7. The method of any of the above embodiments, wherein the desorption conditions comprise a sorbent environment temperature that is lower than the boiling point of the one or more non-aqueous components.

Embodiment 8. The method of any of the above embodiments, wherein the desorption conditions comprise a sorbent environment temperature of 40° C. or less.

Embodiment 9. The method of any of the above embodiments, wherein the sorption conditions comprise a sorbent environment temperature of 15° C. or less.

Embodiment 10. The method of any of the above embodiments, the method further comprising, after exposing the sorbent bed to the sweep gas, cooling the sorbent environment to the temperature of 30° C. or less.

Embodiment 11. The method of Embodiment 10, wherein cooling the sorbent environment comprises performing heat exchange with the sorbent environment with sea water, water from a fresh water source, a heat exchange fluid provided from a liquefied natural gas plant, or a combination thereof, and wherein heating at least a portion of the one or more liquid phase fractions comprises performing heat exchange with at least one of water and air.

Embodiment 12. The method of any of the above embodiments, wherein separating the desorption effluent comprises: separating the desorption effluent at a pressure of 90 kPa-a or less to form: an intermediate gas effluent comprising a molar ratio of the one or more non-aqueous components to CO₂ of less than 2.0, and one or more liquid phase fractions comprising 80 mol % or more of the one or more non-aqueous components; and separating the intermediate gas effluent to form the gas phase effluent comprising 90 mol % or more of CO₂ and at least one liquid phase fraction comprising 80 mol % or more of the one or more non-aqueous components.

Embodiment 13. The method of Embodiment 12, wherein the desorption effluent is separated at a pressure of 70 kPa-a or less.

Embodiment 14. The method of claim 12, wherein separating the intermediate gas effluent comprises: separating the intermediate gas effluent at a pressure of 90 kPa-a to 200 kPa-a to form a second intermediate effluent and at least one additional liquid fraction comprising 80 mol % or more of the one or more non-aqueous components, and separating the second intermediate effluent at a pressure of greater than 200 kPa-a to form the gas phase effluent and at least a third liquid fraction, the third liquid fraction optionally comprising 80 mol % or more of the one or more non-aqueous components.

Embodiment 15. The method of any of the above embodiments, wherein the sweep gas comprises 80 mol % or more of one or more carbon-containing components, or wherein the sweep gas comprises 80 mol % or more of one or more organic components.

Embodiment 16. The method of any of the above embodiments, wherein the CO₂-containing gas comprises a partial pressure of CO₂ of 10 kPa or less.

### Additional Embodiments—CO₂ Capture with Aqueous-base Sweep Gas

Embodiment 1. A method for capturing CO₂, comprising: exposing a CO₂-containing gas to a sorbent bed in a sorbent environment under sorption conditions comprising a sorbent environment temperature of 30° C. or less to form a sorbent bed comprising sorbed CO₂ and a CO₂-depleted effluent; exposing the sorbent bed to a sweep gas under desorption conditions comprising a sorbent environment temperature of 100° C. or less to form a desorption effluent comprising at least a portion of the sorbed CO₂ and at least a portion of the sweep gas, the sweep gas comprising one or more sweep gas components, the sweep gas comprising 5.0 mol % or more of water, a molar ratio of the one or more sweep gas components to CO₂ in the desorption effluent being 1.0 or more; separating the desorption effluent to form a gas phase effluent comprising 90 mol % or more of CO₂ and one or more liquid phase fractions comprising 80 mol % or more of the one or more sweep gas components; and heating at least a portion of the one or more liquid phase fractions to form at least a portion of the sweep gas.

Embodiment 2. The method of Embodiment 1, wherein the sweep gas comprises 80 mol % or more of water.

Embodiment 3. The method of any of the above embodiments, wherein the sorbent bed comprises an amine sorbent, the sorbent bed optionally comprising a solid with infused reactive liquid.

Embodiment 4. The method of Embodiment 3, wherein the amine sorbent comprises 2-methoxy-n-methylbenzylamine, N,N-Bis[3-(methylamino)propyl]methylamine, or a combination thereof.

Embodiment 5. The method of any of the above embodiments, wherein the partial pressure of the one or more non-aqueous components in the desorption conditions is 15 kPa-a or more.

Embodiment 6. The method of any of the above embodiments, wherein the desorption conditions comprise a sorbent environment pressure of 90 kPa-a or less.

Embodiment 7. The method of any of the above embodiments, wherein the desorption conditions comprise a sorbent environment pressure of 70 kPa-a or less.

Embodiment 8. The method of any of the above embodiments, wherein the desorption conditions comprise a sorbent environment temperature of 70° C. or less.

Embodiment 9. The method of any of the above embodiments, wherein the desorption conditions comprise a sorbent environment temperature that is lower than a boiling point of the one or more sweep gas components at 100 kPa-a.

Embodiment 10. The method of any of the above embodiments, the method further comprising, after exposing the sorbent bed to the sweep gas, cooling the sorbent environment to the temperature of 30° C. or less.

Embodiment 11. The method of Embodiment 10, wherein cooling the sorbent environment comprises performing heat exchange with the sorbent environment with sea water, water from a fresh water source, a heat exchange fluid provided from a liquefied natural gas plant, or a combination thereof, and wherein heating at least a portion of the one or more liquid phase fractions comprises performing heat exchange with at least one of water and air.

Embodiment 12. The method of any of the above embodiments, wherein separating the desorption effluent comprises: separating the desorption effluent at a pressure of 90 kPa-a or less to form: an intermediate gas effluent comprising a molar ratio of the one or more sweep gas components to CO₂ of less than 2.0, and one or more liquid phase fractions comprising 80 mol % or more of the one or more sweep gas components; and separating the intermediate gas effluent to form the gas phase effluent comprising 90 mol % or more of CO₂ and at least one liquid phase fraction comprising 80 mol % or more of the one or more non-aqueous components.

Embodiment 13. The method of Embodiment 12, wherein separating the intermediate gas effluent comprises: separating the intermediate gas effluent at a pressure of 90 kPa-a to 200 kPa-a to form a second intermediate effluent and at least one additional liquid fraction comprising 80 mol % or more of the one or more sweep gas components, and separating the second intermediate effluent at a pressure of greater than 200 kPa-a to form the gas phase effluent and at least a third liquid fraction.

Embodiment 14. The method of any of the above embodiments, wherein the CO₂-containing gas comprises a partial pressure of CO₂ of 10 kPa or less.

### Additional Embodiments—Methanol Sweep Gas

Embodiment 1. A method for capturing CO₂, comprising: exposing a CO₂-containing gas to a sorbent bed in a sorbent environment under sorption conditions comprising a sorbent environment temperature of 30° C. or less to form a sorbent bed comprising sorbed CO₂ and a CO₂-depleted effluent; exposing the sorbent bed to a sweep gas under desorption conditions comprising a sorbent environment temperature of 65° C. or less to form a desorption effluent comprising at least a portion of the sorbed CO₂ and at least a portion of the sweep gas, the sweep gas comprising 80 mol % or more of methanol, a molar ratio of methanol to CO₂ in the desorption effluent being 1.0 or more; separating the desorption effluent to form a gas phase effluent comprising 90 mol % or more of CO₂ and one or more liquid phase fractions comprising 80 mol % or more of methanol; and heating at least a portion of the one or more liquid phase fractions to form at least a portion of the sweep gas.

Embodiment 2. The method of Embodiment 1, wherein the sorbent bed comprises an amine sorbent, the sorbent bed optionally comprising a solid with infused reactive liquid.

Embodiment 3. The method of Embodiment 2, wherein the amine sorbent comprises 2-methoxy-n-methylbenzylamine, N,N-Bis[3-(methylamino)propyl]methylamine, or a combination thereof.

Embodiment 4. The method of any of the above embodiments, wherein the partial pressure of the methanol in the desorption conditions is 10 kPa-a or more.

Embodiment 5. The method of any of the above embodiments, wherein the desorption conditions comprise a sorbent environment pressure of 90 kPa-a or less.

Embodiment 6. The method of any of the above embodiments, wherein the desorption conditions comprise a sorbent environment pressure of 70 kPa-a or less.

Embodiment 7. The method of any of the above embodiments, wherein the desorption conditions comprise a sorbent environment temperature of 55° C. or less.

Embodiment 8. The method of any of the above embodiments, wherein the desorption conditions comprise a sorbent environment temperature of 40° C. or less.

Embodiment 9. The method of any of the above embodiments, wherein the sorption conditions comprise a sorbent environment temperature of 15° C. or less.

Embodiment 10. The method of any of the above embodiments, the method further comprising, after exposing the sorbent bed to the sweep gas, cooling the sorbent environment to the temperature of 30° C. or less.

Embodiment 11. The method of Embodiment 10, wherein cooling the sorbent environment comprises performing heat exchange with the sorbent environment with sea water, water from a fresh water source, a heat exchange fluid provided a liquefied natural gas plant, or a combination thereof, and wherein heating at least a portion of the one or more liquid phase fractions comprises performing heat exchange with at least one of water and air.

Embodiment 12. The method of any of the above embodiments, wherein separating the desorption effluent comprises: separating the desorption effluent at a pressure of 90 kPa-a or less to form: an intermediate gas effluent comprising a molar ratio of methanol to CO₂ of less than 2.0, and one or more liquid phase fractions comprising 80 mol % or more of methanol; and separating the intermediate gas effluent to form the gas phase effluent comprising 90 mol % or more of CO₂ and at least one liquid phase fraction comprising 80 mol % or more of methanol.

Embodiment 13. The method of Embodiment 12, wherein the desorption effluent is separated at a pressure of 70 kPa-a or less.

Embodiment 14. The method of Embodiment 12, wherein separating the intermediate gas effluent comprises: separating the intermediate gas effluent at a pressure of 90 kPa-a to 200 kPa-a to form a second intermediate effluent and at least one additional liquid fraction comprising 80 mol % or more of methanol, and separating the second intermediate effluent at a pressure of greater than 200 kPa-a to form the gas phase effluent and at least a third liquid fraction.

Embodiment 15. The method of any of the above embodiments, wherein the CO₂-containing gas comprises a partial pressure of CO₂ of 10 kPa or less.

Certain features have been described using a set of numerical upper limits and a set of numerical lower limits. It should be appreciated that ranges from any lower limit to any upper limit are contemplated unless otherwise indicated. Certain lower limits, upper limits and ranges appear in one or more claims below. All numerical values take into account experimental error and variations that would be expected by a person having ordinary skill in the art.

The foregoing description of the disclosure illustrates and describes the present methodologies. Additionally, the disclosure shows and describes exemplary methods, but it is to be understood that various other combinations, modifications, and environments may be employed and the present methods are capable of changes or modifications within the scope of the concept as expressed herein, commensurate with the above teachings and/or the skill or knowledge of the relevant art.

We claim:

1. A method for recovering a sweep gas, comprising:
heating a sweep liquid to a first temperature to form a sweep gas at a first vapor pressure, the first temperature being equal to or less than a boiling point for the sweep liquid at 100 kPa-a, the first temperature being 85° C. or less;
exposing a sorbent bed in a sorbent environment to at least a portion of the sweep gas, at a sweep pressure in the sorbent environment of 90 kPa-a or less and a sweep temperature in the sorbent environment comprising the first temperature or higher, to form a desorption effluent comprising the sweep gas and at least one desorbed component, the sweep pressure comprising the first vapor pressure or lower;
reducing the temperature of at least a portion of the desorption effluent to a temperature below the first temperature to form a first intermediate effluent enriched in the at least one desorbed component and a first condensed sweep liquid, a pressure during the reducing the temperature being 90 kPa-a or less;
increasing the pressure of at least a portion of the first intermediate effluent to a pressure between 90 kPa-a and 200 kPa-a to form a second intermediate effluent and a second condensed sweep liquid; and
compressing at least a portion of the second intermediate effluent to a pressure greater than 200 kPa-a to form a compressed condensed sweep liquid and a desorption product,
wherein heating the sweep liquid comprises heating a) at least a portion of the first condensed sweep liquid, b) at least a portion of the second condensed sweep liquid, c) at least a portion of the compressed condensed sweep liquid, or d) a combination of two or more of a), b), and c).

2. The method of claim 1, wherein a molar ratio of the sweep gas to the at least one desorbed component in the desorption effluent is greater than 1.0.

3. The method of claim 1, wherein a molar ratio of the sweep gas to the at least one desorbed component in the first intermediate effluent is less than 1.5.

4. The method of claim 1, wherein a molar ratio of the sweep gas to the at least one desorbed component in the second intermediate effluent is less than 0.1.

5. The method of claim 1, wherein the at least one desorbed component comprises CO₂.

6. The method of claim 1, wherein the sweep liquid comprises a boiling point at 100 kPa-a of 20° C. to 85° C.

7. The method of claim 1, wherein the sweep liquid comprises methanol, ethanol, isopropyl alcohol, or a combination thereof.

8. The method of claim 1, wherein the second intermediate effluent, the at least a portion of the second intermediate effluent, or a combination thereof comprises a pressure of 90 kPa-a or more prior to the compressing.

9. The method of claim 1, wherein the second intermediate effluent, the at least a portion of the second intermediate effluent, or a combination thereof comprises a temperature below the first temperature.

10. The method of claim 1, wherein the first intermediate effluent, the at least a portion of the intermediate effluent, or a combination thereof comprises a pressure of 90 kPa-a or less.

11. The method of claim 1, wherein the desorption product comprises a pressure of 500 kPa-a or more.

12. The method of claim 1, further comprising combining the at least a portion of the first intermediate effluent with a recycle portion of the second intermediate effluent prior to the increasing the pressure of the at least a portion of the first intermediate effluent.

13. The method of claim 1, further comprising:
decompressing the at least a portion of the compressed condensed sweep liquid to form a third condensed sweep liquid and a decompression gas comprising one or more desorbed components of the at least one desorbed component, and
combining the at least a portion of the first intermediate effluent with a recycle portion of the decompression gas prior to the increasing the pressure of the at least a portion of the first intermediate effluent,
wherein the at least a portion of the compressed condensed sweep liquid comprises the third condensed sweep liquid.

14. The method of claim 1, further comprising combining the at least a portion of the desorption effluent with a recycle portion of the first intermediate effluent prior to the decreasing the temperature of the at least a portion of the desorption effluent.

15. The method of claim 1, wherein heating the sweep liquid comprises heating a non-aqueous liquid.

16. The method of claim 1, wherein heating the sweep liquid comprises heating a carbon-containing liquid.

17. The method of claim 1, wherein heating the sweep liquid comprises heating an organic liquid.

18. A system for recovering a sweep gas, comprising:
a sweep gas heating stage for heating a sweep liquid at a pressure of less than 90 kPa-a to form a sweep gas, the sweep gas heating stage comprising a liquid inlet, a recycle inlet, and a sweep gas outlet;
a sorbent environment comprising a sorbent bed, the sorbent environment comprising a sorbent sweep gas inlet in fluid communication with the sweep gas outlet, and a desorption effluent outlet;
a first condensation vessel comprising a first condensation vessel inlet in fluid communication with the desorption effluent outlet, a first condensation vessel gas outlet, and a first condensation vessel liquid outlet;
a second condensation vessel comprising a second condensation vessel inlet in fluid communication with the first condensation vessel gas outlet, a second condensation vessel gas outlet, and a second condensation vessel liquid outlet; and
a compression stage comprising a compressor inlet in fluid communication with the second condensation vessel gas outlet, a compression gas outlet, and a compression liquid outlet,
wherein the recycle inlet is in fluid communication with at least one of the first condensation vessel liquid outlet, the second condensation vessel liquid outlet, and the compression liquid outlet.

19. The system of claim 18, wherein the system further comprises a sweep gas reservoir in fluid communication with the liquid inlet, the sweep gas reservoir containing a carbon-containing sweep liquid having a boiling point at 100 kPa-a of 85° C. or less.

20. The system of claim 18, wherein the sorbent bed comprises a sorbent infused with reactive liquid.

21. The system of claim 18, where at least one of the first condensation vessel and the second condensation vessel comprises a vessel capable of operating at a pressure of 90 kPa-a or less.
